(19) United States
(12) Patent Application Publication
(10) Pub. No.: US 2003/0061112 A1
(43) Pub. Date: Mar. 27, 2003

(54) Systems and methods for exclusively distributing flowers having printing thereon

(76) Inventor: Roland N. Walker, Idaho Falls, ID (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/964,990

(22) Filed: Sep. 26, 2001

(51) Int. Cl. G06F 17/60

(52) U.S. Cl. 705/26

(57) ABSTRACT

Systems and methods for exclusively distributing flowers. A purchaser places a flower order that is processed at and shipped from one of a limited number of warehouses to an intended recipient. The ability to place such an order is optionally made exclusive to individuals that satisfy pre-established purchasing criteria. The flower order may be for a floral delivery that includes a message printed on the flowers. The purchaser may optionally determine the message printed on the flowers. The processing of the flower order, including the printing of the message on the flowers, is performed at the warehouse. The flower order is prepared for delivery to an intended recipient, wherein the delivery may include the use of an express delivery service to expeditiously send the processed flower order to the intended recipient.

### BACKGROUND OF THE INVENTION

1. Field of the Invention

The present invention relates to systems and methods for distributing flowers. More particular, the present invention relates to developing exclusive rights to purchase a printed flower, receiving a request to purchase, and responding to the request by printing on a portion of a flower, packaging the flower, and using an express service to deliver the printed flower to a recipient.

2. Background and Related Art

Flowers, such as single flowers, bouquets, or floral arrangements, have been given to recipients for a variety of reasons. For example, flowers are given to celebrate such occasions as anniversaries, birthdays, graduations, promotions, retirements, and other meaningful events. Flowers have also been used to express feelings of appreciation, friendship, love, romance, and sympathy. Often, the flowers are accompanied by a card written by the purchaser or by the florist on behalf of the purchaser to communicate a particular message or expression.

The purchasing of flowers is typically accomplished through the use of a local florist. The florist may be considered local in relation to the purchaser and/or the recipient. A purchaser may place an order with a local florist in person, by telephone, via facsimile, or through the internet. Upon placing the order, the purchaser may choose to hand-deliver the flowers to the recipient or to have a delivery person employed by the local florist deliver the flowers to the recipient on behalf of the purchaser.

Because flowers are typically considered fungible products, floral service organizations have been created in the floriculture industry to assist purchasers by allowing local florists to exchange orders for out-of-town deliveries. As such, a purchaser may place an order with a particular florist affiliated with a floral service organization or with the organization directly to cause the flowers to be prepared by a local florist and delivered to the intended recipient. When the florist is local with relation to the recipient, the delivery may be made on the same-day that the order is placed by the purchaser.

Since a local florist provides the preparation and delivery of the flowers, the availability of the flowers is subject to the local florist. When an order is placed, for example, with a floral service organization via the internet, the customer accesses the floral service organization website, selects the desired flowers for purchase, and provides the postal code corresponding to the delivery location to identify whether or not the flowers are available in the recipient's area. Upon determining that the flowers are available, the order is placed and forwarded to the local florist, who prepares and delivers the flowers purchased.

While the creation of a floral service organization has facilitated cooperation among florists to fill out-of-town orders, orders cannot be placed when the flowers are not available to the local florists. Moreover, the association of a variety of florists in the organization results in a varying flower quality, wherein the quality depends on the supply received by the local florist that prepares the flower order.

### SUMMARY OF THE INVENTION

The present invention relates to systems and methods for distributing flowers. More particular, the present invention relates to developing exclusive rights to purchase a printed flower, receiving a request to purchase, and responding to the request by printing on a portion of a flower, packaging the flower, and using an express service to deliver the printed flower to a recipient.

Implementation of the present invention takes place in association with a computer device that may be used to receive and/or record orders for flowers that are to be prepared for and distributed to intended recipients. The orders may be placed by purchasers via facsimile, electronic mail (“e-mail”), telephone, or the internet. All flower orders are prepared at and shipped from one of a limited number of warehouses to the intended recipients. An express delivery service is used to deliver the flower orders.

In one implementation, the orders are for flowers having a message (e.g. text and/or graphics) printed on one or more of the flowers. Each order identifies the message that is to be printed. Thus, the process of preparing the order at one of the limited number of warehouses includes printing the desired message onto one or more of the flowers ordered. Once the message is printed and the flowers are otherwise prepared, the printed flowers are sent from the warehouse via an express delivery service to the intended recipient.

In another implementation the ability to purchase is exclusively reserved to members that satisfy a particular purchasing criteria. For example, one or more requirements are defined to determine whether or not an individual is entitled to place an order for flowers. (An individual that is entitled to place an order may be considered a member.) Once the requirements are established, a potential member is identified and a sample product is delivered with an exclusive invitation to become a member. Upon acceptance of the invitation, the member may order printed flowers.

While the methods and processes of the present invention have proven to be particularly useful in the floriculture industry, those skilled in the art can appreciate that the methods and processes of the present invention may be used in a variety of different industries to exclusively distribute products to intended recipients.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1;

FIG. 3 illustrates a flow chart that provides a representative embodiment of a method for distributing printed flowers from a central location; and

FIG. 4 illustrates an exemplary embodiment of a method for providing exclusive membership to determine purchasing privileges.

### DETAILED DESCRIPTION OF THE INVENTION

The present invention relates to systems and methods for distributing flowers. More particular, the present invention relates to developing exclusive rights to purchase a printed flower, receiving a request to purchase, and responding to the request by printing on a portion of a flower, packaging the flower, and using an express service to deliver the printed flower to a recipient.

In the disclosure and in the claims the term “printed flower” shall refer to text and/or graphics that is printed, stamped, engraved, embossed, or otherwise provided on a flower or any portion thereof, including one or more petals or leaves. Furthermore, in the disclosure and in the claims the term “message” shall refer to the text and/or graphics that is provided on a printed flower.

The following disclosure of the present invention is grouped into two subheadings, namely “Exemplary Operating Environment” and “Distributing Flower Orders.” The utilization of the subheadings is for convenience of the reader only and is not to be construed as limiting in any sense.

### Exemplary Operating Environment

Embodiments of the present invention embrace the use of a computer device to receive and/or record orders for flowers that are to be prepared for and distributed to intended recipients. The orders may be placed by purchasers via facsimile, electronic mail (“e-mail”), telephone, or the internet. All flower orders are prepared at and shipped from one of a limited number of warehouses to the intended recipients, as will be further explained below.

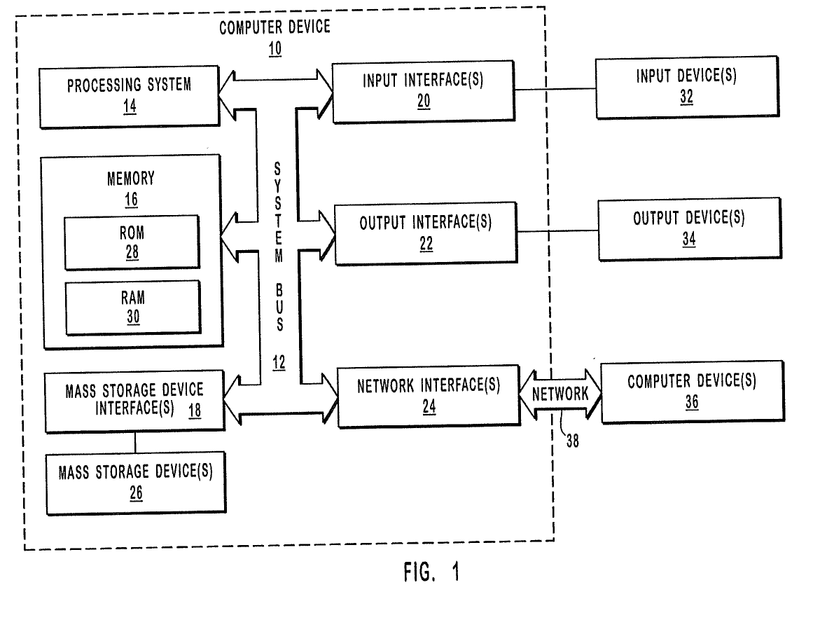

FIG. 1 and the corresponding discussion are intended to provide a general description of a computer device as a suitable operating environment to receive and/or record orders for flowers that are to be prepared for and distributed to intended recipients. One skilled in the art will appreciate that the invention may be practiced by one or more computing devices and in a variety of system configurations, including in a networked configuration.

Embodiments of the present invention embrace one or more computer readable media that may be used to receive and/or record orders for flowers that are to be prepared for and distributed to intended recipients, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for receiving and/or recording orders for flowers that are to be prepared for and distributed to intended recipients includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

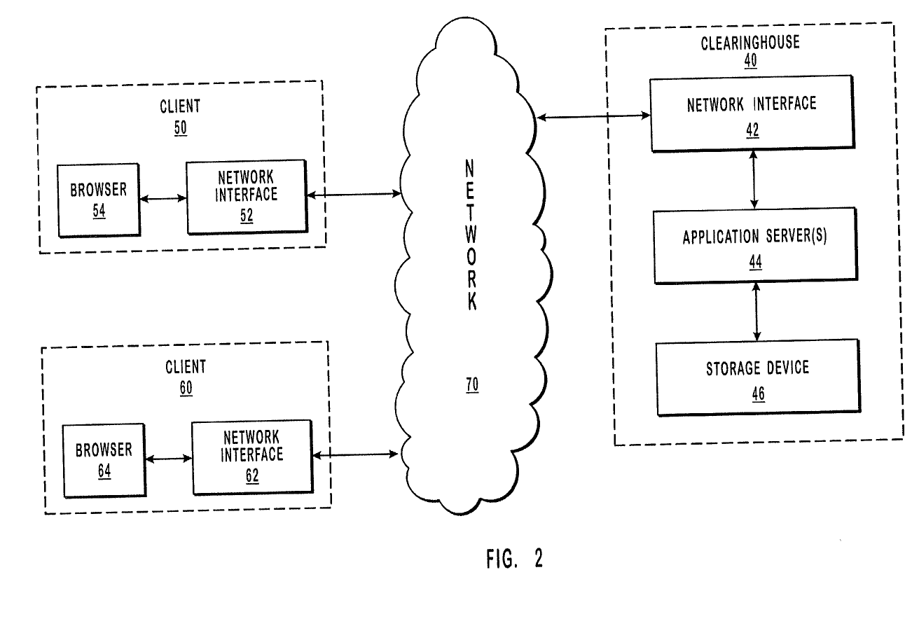

While those skilled in the art will appreciate that the invention may be practiced in networked computing environments with many types of computer system configurations, FIG. 2 represents an embodiment of the present invention that enables clients to place orders for flowers across a network so as to have the flowers prepared for and distributed to intended recipients. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the internet.

In FIG. 2, clearinghouse 40 represents a system configuration that includes one or more servers that are used to receive and/or record orders for flowers that are to be prepared for and distributed to intended recipients. By way of example, clearinghouse 40 may be a single server in cases where a single server can process and preserve the entire amount of information required to perform the methods and systems of the present invention, as will be further explained below. Alternatively, clearinghouse 40 may be a conglomeration of servers that process and preserve a high volume of information.

In accordance with the present invention, a purchaser may submit an order for flowers that are to be delivered to a given recipient. The orders may be placed via facsimile, electronic mail (“email”), telephone, or the internet. When an order is placed by facsimile, the order may be sent from a fax machine or computer device to clearinghouse 40, which preserves an electronic copy of the order. Similarly, when an order is placed via email, the order may be sent from a computer device, across a network, to clearinghouse 40, which preserves an electronic copy of the order.

The emergence of the internet has enabled a very large number of computer devices across the world to be connected across a wide area network in order to participate in global communication. The following is a discussion of an embodiment of the present invention that includes a plurality of clients, illustrated as clients 50 and 60, that are connected to clearinghouse 40 across the internet, illustrated as network 70, in order to receive and/or record orders for flowers that are to be prepared for and distributed to intended recipients.

With reference to FIG. 2, clients 50 and 60 each include a network interface (respectively illustrated as network interfaces 52 and 62) and a Web Browser (respectively illustrated as browsers 54 and 64). Network interface 52 is a communication mechanism that allows a client, such as client 50 to communicate to clearinghouse 40 by a network 70, such as the internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a web page that enables the transmission of information necessary to submit an order for flowers that are to be prepared for and distributed to intended recipients.

Clearinghouse 40 includes network interface 42, application servers 44, and storage device 46. Network interface 42 is a communication mechanism that allows clearinghouse 40 to communicate with one or more clients by a network 70. Application servers 44 include one or more servers for processing and/or preserving information, and may be employed for providing and maintaining a web page that enables the ordering of flowers. Storage device 46 includes one or more storage devices for preserving information, such as transactional information and/or purchaser information to perform the methods enclosed herein. In one embodiment, storage device 46 further preserves membership information when the ability to purchase flowers is reserved to individuals that meet a particular criteria, as will be further explained below. Storage device 46 may be internal or external to application servers 44. Thus, a user at one of the clients, such as client 50, may access a web page maintained by one or more of the application servers 44 and electronically place an order to purchase flowers that are to be prepared for and distributed to intended recipients. The order is received by clearinghouse 40, processed at one of a limited number of warehouses, and shipped from the warehouse to the intended recipients, as will be further explained below.

While the discussion above has presented a representative system configuration for implementing the present invention, those skilled in the art will appreciate that the methods of the present invention and processes thereof may be implemented in a variety of different system configurations.

### Distributing Flower Orders

As provided above, embodiments of the present invention embrace receiving orders for flowers that are to be prepared for and distributed to intended recipients. The orders may be placed by purchasers via facsimile, electronic mail (“e-mail”), telephone, the internet, or through another manner of communication. All flower orders are prepared at and shipped from one of a limited number of warehouses to the intended recipients, whether the intended recipients are located across town, in another state, or in another country, as will be further explained below.

In one embodiment, the orders are for flowers having a message (e.g. text and/or graphics) printed, stamped, engraved, embossed, or otherwise provided on one or more of the flowers or parts thereof, such as on a petal or leaf, prior to being shipped. In one embodiment, the message is a standard message that is printed on a part of a flower. In another embodiment, the purchaser is able to define or otherwise provide the text and or graphic that is to be printed on the flower so as to provide a customizable message.

In the embodiment where a customizable message is provided, each order received identifies the message (e.g. text and/or graphics) that is to be printed on the flower. Thus, the process of preparing the order at one of the limited number of warehouses includes printing the desired message onto one or more of the flowers ordered. Once the message is printed and the flowers are otherwise prepared, such as by being packaged for shipment, the printed flowers are sent from the warehouse to the intended recipients. In one embodiment the prepared flowers are shipped via an express delivery service to the intended recipients.

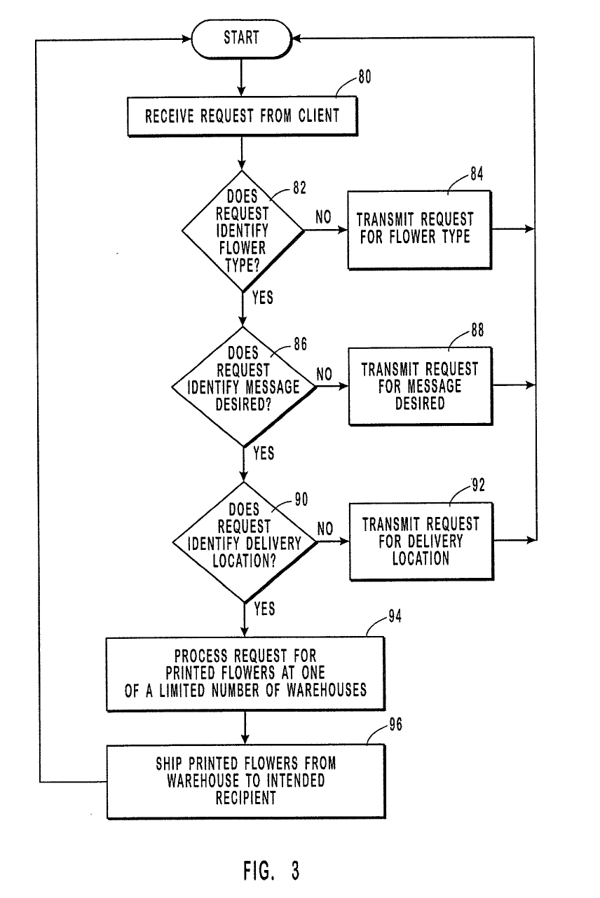

1. With reference to FIG. 3, an exemplary embodiment is illustrated for receiving requests for printed flowers, processing the requests, and delivering the printed flowers to the corresponding recipients. In FIG. 3, execution begins at step 80, where a request is received from a client. A determination is then made at decision block 82 as to whether or not the request received identifies the flower type desired by the client. The flower type identified may be a rose or another type of flower or flowers that is being ordered. The flower type may also include the color of the flower, such as a red rose. The flower type also includes the number of flowers, such as a dozen roses. Furthermore, the flower type may include the entire flower, such as a long stem rose, or may indicate only a part thereof, such as rose petals, that are to be delivered to a particular recipient. For example, the systems and methods of the present invention may be used to provide printed flowers in the form of individual printed petals that may be disseminated at a social event, such as a wedding or a sporting event. (The petals are individual when they are detached from the flower.) If the flower type is not identified in the request, execution proceeds to step 84, where a request is transmitted to the client to provide the flower type. Execution then returns back to start in order to receive a response from the client in the form of an updated request that may be processed.

Returning back to decision block 82, if it is determined that the request received at step 80 identifies a particular flower type, execution proceeds to decision bock 86 for a determination as to whether or not the request identifies a message desired to be printed on the flower type. If it is determined at decision block 86 that the message desired to be printed on the flower type is not identified in the request, execution proceeds to step 88 in order to transmit a request to the client to identify the message desired and execution returns back to start in order to receive a response from the client in the form of an updated request that may be processed.

Returning back to decision block 86, when it is determined that the request identifies the message desired to be printed, execution proceeds to decision block 90 for determination as to whether or not the request identifies the location where the printed flowers are to be delivered. If it is determined at decision block 90 that the delivery location is not identified, execution proceeds to step 92 for a transmission of a request for the delivery location and then execution proceeds back to start in order to receive a response from the client in the form of an updated request that may be processed.

Once the flower type, message and delivery location are identified, execution proceeds to step 94, where the order is processed. While orders may be received from around the world, each of the orders may be processed at one of a limited number of warehouses. A limited number of warehouses may be used rather than local florists in order to enable the process of printing on the flowers and to regulate the quality of the flowers shipped. The processing of an order includes selecting the flower type identified, printing the desired message thereon, and preparing the printed flowers for shipment. Execution then proceeds to step 96, where the printed flowers are shipped from the warehouse to the intended recipient. The processing of shipping includes using an express delivery service to deliver the printed flowers to the intended recipient. The process of shipping may further include using the computer device to provide shipping information in order to automate the shipping process. Execution then proceeds back to start in order to process another request.

In a further embodiment of the present invention, the ability to purchase is made exclusive by reserving the right to purchase printed flowers to individuals that satisfy a particular purchasing criteria. The individuals that satisfy the criteria may be considered “members.” For example, one or more requirements are defined to determine whether or not an individual is entitled to place an order for flowers. Once the requirements are established, a potential member is identified and a sample product is delivered with an exclusive invitation to become a member. Upon acceptance of the invitation, the member may order printed flowers.

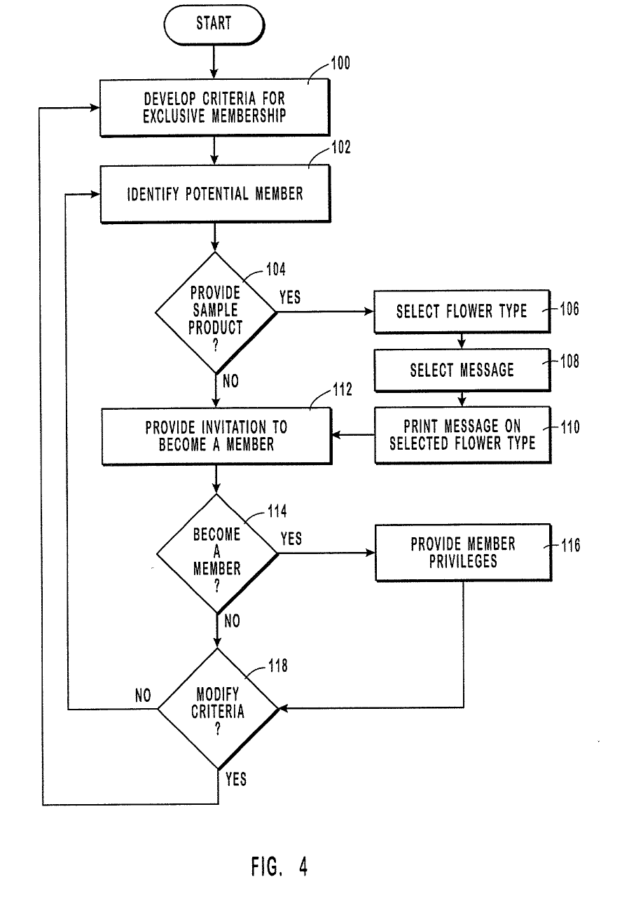

With reference to FIG. 4, an exemplary embodiment is illustrated that relates to the creation of exclusive memberships that provide privileges to purchase printed flowers. The ability to purchase printed flowers may be made exclusive in order cause the printed flowers to remain uncommon. In FIG. 4, execution begins at step 100, where the development of criteria is performed to determine the requirements for purchasing printed flowers. An example of the criteria that may be developed includes ownership of a new Lexus® automobile. For example, an offer purchase printed flowers may be extended to Lexus® owners. Thus, subsequent to the purchase of a new Lexus® vehicle, the purchaser may receive one or more flowers having “Lexus®” and the corresponding logo printed thereon and an invitation to purchase similar printed flowers having customizable messages thereon, as will be further explained below.

Therefore, once the requirements for membership have been developed at step 100, execution proceeds to step 102 for the identification of a potential customer. Execution then proceeds to decision block 104 for determination as to whether or not to provide a sample product to the potential member. As with the example of the Lexus® owner above, if it is determined at decision block 104 that a sample product is to be provided to the potential member, execution proceeds to step 106 for the selection of a particular flower type (e.g. kind, quantity, color, etc.) that is to be used as the sample product. Execution then proceeds to step 108 for the selection of a message that is to be printed onto the flower type selected in step 106. At step 110 the message selected in 108 is printed onto the selected flower type and execution proceeds to step 112 to extend an invitation to the potential member to purchase printed flowers. Alternatively, if it is determined at decision block 104 that a sample product is not to be provided to the potential member, execution proceeds directly to step 112.

At step 112, an invitation to become a member in order to be able to purchase printed flowers is provided to the potential member identified in step 102. Once an invitation is extended, a determination is made at step 114 as to whether or not the potential member desires to become a member. If it is determined that the individual desires to become a member, execution proceeds to step 116 to extend member privileges to the individual of being able to purchase printed flowers. In a further embodiment, the membership information is preserved on a computer-readable medium and is accessible by a computer device. Execution proceeds to decision block 118. Alternatively, if an individual does not desire to become a member, execution proceeds directly to decision block 118.

At decision block 118, a determination is made as to whether or not to modify the criteria for exclusive membership. If it is determined at decision block 118 to not modify the criteria for exclusive membership, execution returns back to step 102 for the identification of another potential member. Alternatively, if it is determined at decision block 118 that the criteria developed for exclusive membership is to be modified, execution returns back to step 100 in order to develop new criteria for exclusive membership.

Thus, as discussed herein, the embodiments of the present invention embrace systems and methods exclusively distributing flowers that optionally have printing thereon. Moreover, the present invention relates to developing exclusive membership rights to purchase a printed flower, receiving a request to purchase, and responding to the request by printing on a flower, packaging the flower, and using an express service to deliver the printed flower to a recipient.

While the methods and processes of the present invention have proven to be particularly useful in the floriculture industry, those skilled in the art can appreciate that the methods and processes of the present invention may be used in a variety of different industries to exclusively distribute products to intended recipients. As such, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a system that includes a computer device, a method for processing a flower order and delivering the order to an intended recipient, the method comprising the steps for:
receiving the flower order from a purchaser, wherein the order is received by the computer device;
processing the order at one of a limited number of warehouses; and
delivering the order to the intended recipient, wherein the order is delivered from the warehouse to the recipient by an express delivery service.

2. A method as recited in claim 1, wherein the step for processing includes:
providing at least a portion of a flower; and
printing a message on the portion.

3. A method as recited in claim 2, wherein the portion is a petal of the flower.

4. A method as recited in claim 3, wherein the petal is detached from the flower and is for dissemination at a social event.

5. A method as recited in claim 2, wherein the step for processing further includes:
identifying a flower type; and
identifying the message.

6. A method as recited in claim 5, wherein the message is provided in the flower order and determined by the purchaser.

7. A method as recited in claim 2, wherein the step for processing further includes identifying the intended recipient.

8. A method as recited in claim 2, wherein the step for processing further includes determining whether the purchaser is entitled to purchase by satisfying a purchasing requirement.

9. A method as recited in claim 1, wherein the flower order is received via one of:
(i.) facsimile; or
(ii.) email.

10. A method as recited in claim 1, wherein the intended recipient is located remotely with respect to the warehouse.

11. In a networked system that includes a client and a server, a method for processing a flower order for delivery to a recipient, the method comprising the steps for:
receiving the flower order at the server, wherein the order was sent from the client across a network to the server;
processing the order at one of a limited number of warehouses; and
delivering the order to the recipient.

12. A method as recited in claim 11, wherein the network is the internet.

13. A method as recited in claim 11, wherein the step for processing the order includes:
providing at least a portion of a flower; and
printing a message on the portion.

14. A method as recited in claim 13, wherein the portion is a petal of the flower.

15. A method as recited in claim 11, wherein the step for processing further includes identifying the message.

16. A method as recited in claim 15, wherein the message is identified in the flower order.

17. A method as recited in claim 11, wherein the step for processing further includes determining whether the purchaser is entitled to purchase by satisfying a purchasing requirement.

18. A computer program product for implementing within a computer system a method for processing flower orders, the computer program product comprising:
computer readable medium for providing computer program code means utilized to implement the method, wherein the computer program code means is comprised of executable code for implementing the steps for:
electronically receiving a flower order,
identifying a message that is to be printed onto at least a portion of a flower; and
identifying recipient information.

19. A computer program product as recited in claim 18, wherein the computer program code means is further comprised of executable code for implementing the step for generating delivery information.

20. A computer program product as recited in claim 18, wherein the message to be printed is provided in the flower order.
